(19) United States
(12) Patent Application Publication
(10) Pub. No.: US 2026/0091559 A1
(43) Pub. Date: Apr. 2, 2026

(54) JOINING APPARATUS AND HEATING SYSTEM

(71) Applicant: NIPPON AVIONICS CO., LTD., Yokohama-shi (JP)

(72) Inventor: Tadahiro IWATSUKI, Yokohama-shi (JP)

(21) Appl. No.: 19/344,264

(22) Filed: Sep. 29, 2025

(30) Foreign Application Priority Data
Sep. 30, 2024 (JP) 2024-170497

(51) Int. Cl. B29C 65/08; B29C 65/14

(52) U.S. Cl. CPC B29C 65/08; B29C 65/1441

(57) ABSTRACT

A joining apparatus includes a preheating device heating a stage in noncontact before joining, thereby preheating at least a first member of a workpiece. The preheating device includes a light source that faces a side surface of the stage and emits heating light for heating the stage; and a reflecting surface that has a hood shape and covers the light source from a side opposite to the side surface. The reflecting surface reflects, toward the side surface, light that has been reflected by the side surface among the heating light.

### TECHNICAL FIELD

The present disclosure relates to a joining apparatus and a heating system.

### BACKGROUND

Patent literature 1 (Japanese Patent Laid-Open No. 2012―4268) discloses a joining apparatus that applies an ultrasonic vibration to a workpiece when joining the first member and the second member of the workpiece.

In the joining apparatus described in patent literature 1, a heater for joining is attached to an ultrasonic horn. In this configuration, for example, since the heater is a foreign substance for the ultrasonic horn, the ultrasonic vibration may be unstable. The inventor of the present disclosure arrived at ultrasonically vibrating a stage that supports at least one of the first member and the second member of a workpiece. However, in this case as well, it is sometimes necessary to heat the stage for preheating of the workpiece before joining. If the heater is brought into contact with the stage to heat it, the ultrasonic vibration may be unstable, like the joining apparatus described in patent literature 1. Although noncontact heating of the stage is possible, the heating efficiency may not be high in noncontact heating. Note that the problem of heating efficiency in noncontact heating is a common problem in noncontact heating.

### SUMMARY

It is the first object of the present disclosure to efficiently heat, in noncontact, a stage that applies an ultrasonic vibration to a workpiece. It is the second object of the present disclosure to efficiently heat a heating target in noncontact.

In order to achieve the above object of the present disclosure, there is provided a joining apparatus comprising (i) a stage including a support surface that is configured to support at least a first member among the first member and a second member included in a workpiece, and a first side surface that connects to the support surface and extends in a direction different from the support surface; (ii) a heater tool configured to heat the workpiece from a side of the second member in a state in which the second member is arranged on the first member supported by the support surface, thereby joining the first member and the second member; (iii) a vibration output device including a vibrator that is configured to ultrasonically vibrate and configured to cause the stage to ultrasonically vibrate during the joining; and (iv) a first preheating device configured to heat the stage in noncontact before the joining, thereby preheating at least the first member of the workpiece, (v) wherein the first preheating device includes: (iv-i) a light source that faces the first side surface of the stage and is configured to emit heating light for heating the stage; and (iv-ii)a reflecting surface that has a hood shape and covers the light source from a side opposite to the first side surface, the reflecting surface being configured to reflect, toward the first side surface, light that has been reflected by the first side surface among the heating light.

According to the above-described configuration, it is possible to efficiently heat, in noncontact, a stage that applies an ultrasonic vibration to a workpiece.

According to the present disclosure, there is provided a heating system comprising (i) a heating device configured to heat the heating target in noncontact, including (i-i) a light source configured to face a heating target and emit heating light for heating the heating target and (i-ii) a reflecting surface that has a hood shape and covers the light source from a side opposite to the heating target and (ii) a support member configured to support the heating device at a position at which the reflecting surface is able to reflect, toward the heating target, light that has been reflected by the heating target among the heating light.

According to the above-described configuration, it is possible to efficiently heat a heating target in noncontact.

### BRIEF DESCRIPTION OF DRAWINGS

FIG. 1 shows a perspective view of the main part of a joining apparatus according to the embodiment of the present disclosure and a view showing the configuration of the control system of the joining apparatus.

FIG. 2 shows a perspective view of the main part of the joining apparatus according to the embodiment of the present disclosure and a view showing the configuration of the control system of the joining apparatus.

FIG. 3 is a perspective view showing a part of the joining apparatus according to the embodiment of the present disclosure, showing the sections of some elements.

FIG. 4 is a perspective view showing a part of the joining apparatus according to the embodiment of the present disclosure, showing the sections of some elements.

FIG. 5 is a perspective view showing a part of the joining apparatus according to the embodiment of the present disclosure.

FIG. 6 is a schematic sectional view showing a part of the joining apparatus according to the embodiment of the present disclosure.

FIG. 7 is a schematic sectional view of a preheating device according to the embodiment of the present disclosure.

### DETAILED DESCRIPTION

The embodiment of the present disclosure will now be described in detail with reference to the accompanying drawings. It should be noted that the X direction, the Y direction, and the Z direction in the following explanation are directions orthogonal to one another. The +Z direction is defined as an upward direction, and the -Z direction is defined as a downward direction. The number of members to be described below is not particularly limited. In particular, a plurality of members shown in the drawings may be a single member or the number of members may be different from the number shown in the drawings.

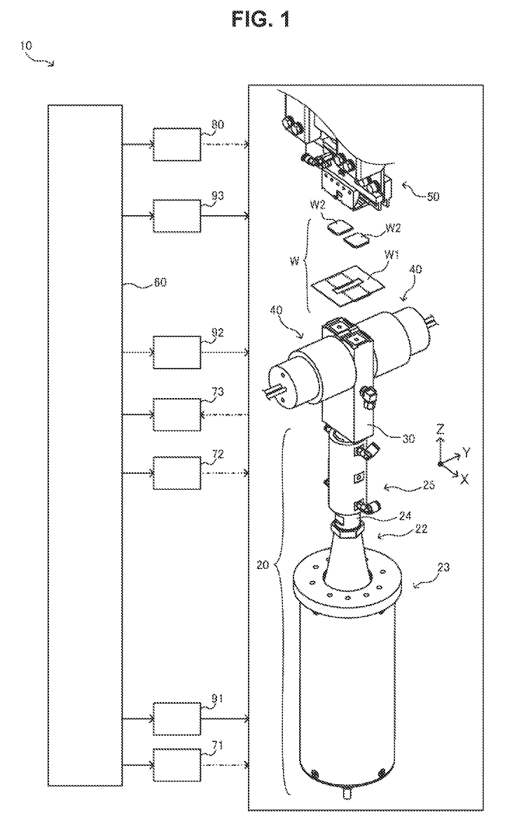

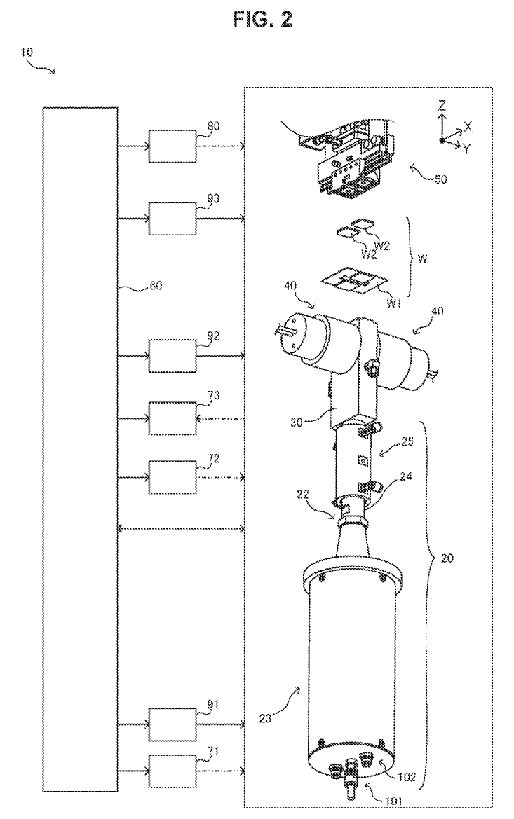

A joining apparatus 10 according to the embodiment shown in FIGS. 1 and 2 is configured to heat a workpiece W including a first member W1 and a plurality of second members W2 and join the first member W1 and the plurality of second members W2. The joining apparatus 10 applies an ultrasonic vibration to the workpiece W during joining. The joint strength is thus improved. The joining apparatus 10 performs soldering or thermocompression as joining. The joining apparatus 10 may be configured to perform resistance welding as joining. The joining apparatus 10 may be configured to perform other joining.

The joining apparatus 10 includes a vibration output device 20, a stage 30, two preheating devices 40, a heater tool 50, a controller 60, cooling devices 71 and 72, an intake device 73, a driving device 80, and power supply circuits 91 to 93.

The vibration output device 20 is configured to generate an ultrasonic vibration and output it to the stage 30. As shown in FIGS. 1 to 4, the vibration output device 20 includes a vibrator 21 that ultrasonically vibrates, a horn 22 that amplifies the vibration of the vibrator 21, and a support member 23 that supports the vibrator 21 and the horn 22. The vibration output device 20 further includes a vibration transmission member 24 that transmits the vibration of the horn 22 to the stage 30, and a cooling mechanism 25 that cools the vibration transmission member 24. The members 21 to 25 extend along the Z direction.

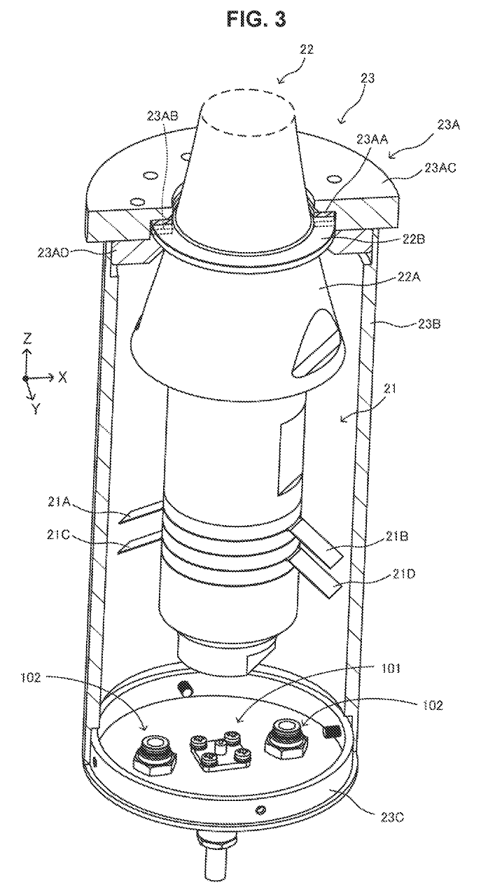

As shown in FIG. 3, the vibrator 21 is a Langevin type vibrator. Terminals 21A to 21D of the vibrator 21 are connected, via wirings (not shown), to a connector 101 fixed to the support member 23. The connector 101 is connected to the power supply circuit 91 (FIGS. 1 and 2) via a wiring (not shown).

The horn 22 includes a horn main body 22A formed into a truncated cone shape, and a flange 22B protruding from the side surface of the horn main body 22A and having an annular shape (here, a doughnut plate shape).

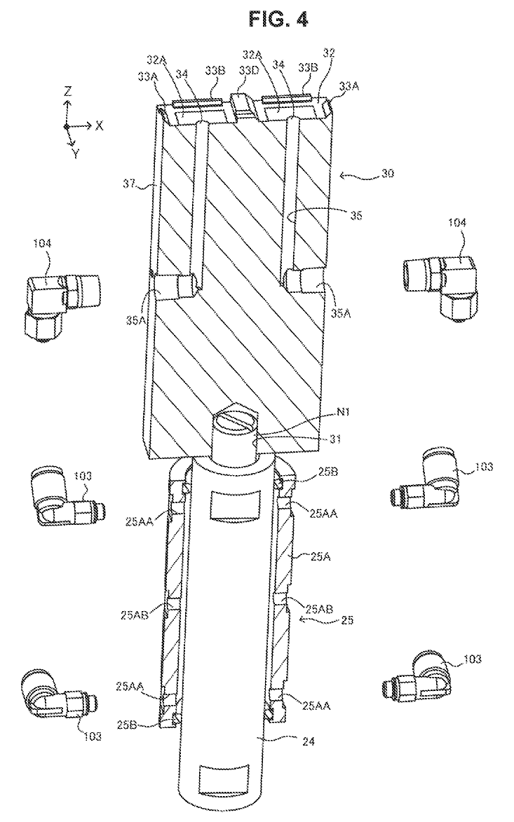

The lower end of the horn main body 22A is connected to the vibrator 21, and the upper end of the horn main body 22A is connected to the vibration transmission member 24 (FIG. 4). Any suitable connection method may be employed to connect these. For example, threaded holes open in each of the lower surface of the horn main body 22A and the upper surface of the vibrator 21, and the horn main body 22A and the vibrator 21 are connected by double-ended screw threadably engaging with the threaded holes. In a similar manner, the horn main body 22A and the vibration transmission member 24 can be connected. The horn main body 22A amplifies the vibration of the vibrator 21, more specifically the amplitude thereof, and transmits the amplified vibration to the vibration transmission member 24.

The flange 22B protrudes from the position of a nodal point (node) generated on the horn main body 22A when the horn main body 22A ultrasonically vibrates.

The support member 23 is fixed to the flange 22B. The support member 23 also functions as a container that stores the vibrator 21. The support member 23 is supported by a support mechanism (not shown) and thus fixed to a predetermined position of the joining apparatus 10. The support member 23 includes a connecting member 23A having an annular plate shape (here, a doughnut plate shape) and connected to the flange 22B, a tubular member 23B (here, a cylindrical member) extending downward from the connecting member 23A, and a cover 23C that covers the lower end of the tubular member 23B.

The connecting member 23A includes an elastic member 23AA, an elastic member 23AB, a clamp member 23AC, and a clamp member 23AD. These are each formed into an annular plate shape (here, a doughnut plate shape). The clamp members 23AC and 23AD clamp the flange 22B of the horn 22 from above and below via the elastic members 23AA and 23AB, and are fixed to each other in this state. The connecting member 23A is thus connected to the flange 22B. The flange 22B is provided at the nodal point of the horn main body 22A and does not vibrate basically but may slightly vibrate. The connecting member 23A can absorb the vibration by the elastic members 23AA and 23AB.

The tubular member 23B has an upper end fixed to the connecting member 23A, and a lower end fixed to the cover 23C. The tubular member 23B covers the periphery of the vibrator 21 in a state of not contacting the vibrator 21, that is, with a gap from the vibrator 21.

The connector 101 and joints 102 are fixed to the cover 23C that covers the lower end of the tubular member 23B, in a state of extending through the cover 23C. As described above, the connector 101 is connected to the vibrator 21 and the power supply circuit 91 (FIGS. 1 and 2) via wirings (not shown). The joints 102 are connected to the cooling device 71 (FIGS. 1 and 2) via tubes (not shown).

The power supply circuit 91 connected to the connector 101 applies a high-frequency driving voltage to the terminals 21A to 21D of the vibrator 21. The vibrator 21 thus ultrasonically vibrates. The vibrator 21 vibrates by expanding and contracting in the Z direction. That is, the vibrator 21 outputs a vibration along the Z direction. The vibration of the vibrator 21 is transmitted to the horn 22, amplified by the horn 22, and transmitted to the vibration transmission member 24.

The cooling device 71 supplies a gas into the tubular member 23B via the joints 102 and the tubes (not shown), thereby cooling the vibrator 21 that generates heat upon application of the driving voltage. The support member 23 also serves as a cooling mechanism that cools the vibrator 21 by the cooling device 71. The cooling device 71 is, for example, a blowing device (a fan, a blower, a compressor, a pump, and the like) that sends air (including compressed air) into the tubular member 23B via the joints 102. The cooling device 71 may be configured as an intake device that takes in air inside the tubular member 23B and thus draws air outside the tubular member 23B into the tubular member 23B, thereby cooling the vibrator 21. The cooling device 71 may be configured as a liquid cooling device that performs cooling by an insulating liquid. The cooling device 71 serving as a blowing device may directly be fixed to the cover 23C.

As shown in FIG. 4, the vibration transmission member 24 has a rod shape and extends in the Z direction. The lower end of the vibration transmission member 24 is connected to the upper end of the horn 22, as described above. The upper end of the vibration transmission member 24 is connected to the lower end of the stage 30. Any suitable connection method may be employed. Here, a threaded hole 31 opens in the lower surface of the stage 30, a threaded hole (not shown) opens in the upper surface of the vibration transmission member 24 as well, and these are connected by a double-ended screw N1 threadably engaging with these threaded holes. Note that the threads of the double-ended screw N1 and the threaded hole 31 are not shown in FIG. 4. The vibration transmission member 24 transmits the ultrasonic vibration from the horn 22 to the stage 30. At this time, the vibration transmission member 24 transmits the vibration (particularly, the amplitude) without amplifying it. That is, the vibration transmission member 24 is configured as a 1× booster.

The stage 30 connected to the vibration transmission member 24 is heated by the preheating devices 40 (FIGS. 1 and 2), as will be described later. The heat is transmitted to the vibration transmission member 24. The heat generated by driving the vibrator 21 may be transmitted to the vibration transmission member 24 via the horn 22. To block transmission of the heat from the side of the stage 30 or the heat from the side of the vibrator 21 to the opposite side, the vibration transmission member 24 is cooled by the cooling mechanism 25.

The cooling mechanism 25 includes a tubular member (here, a cylindrical member) 25A, and two seal members 25B such as O-rings. The two seal members 25B are arranged at the upper and lower ends of the tubular member 25A. The tubular member 25A is fixed to the vibration transmission member 24 via the seal members 25B. The tubular member 25A covers the periphery of the vibration transmission member 24 with a gap from the vibration transmission member 24. A plurality of through holes 25AA are formed at the upper end portion and the lower end portion of the tubular member 25A. The joints 103 are respectively connected to through holes 25AA. Each joint 103 is fitted in or threadably engages with the through hole 25AA and is thus connected to the through hole 25AA. The joints 103 are connected to the cooling device 72 (FIGS. 1 and 2) via tubes (not shown). The cooling mechanism 25 is configured to cool the vibration transmission member 24 by the cooling device 72.

The cooling device 72 supplies a gas into the tubular member 25A via the joints 103 and the tubes (not shown), thereby cooling the vibration transmission member 24. The cooling device 72 is, for example, a blowing device (a fan, a blower, a compressor, a pump, and the like) that sends air (including compressed air) into the tubular member 25A via the joints 103 and the tubes (not shown). The sent air flows between the tubular member 25A and the vibration transmission member 24 along the vibration transmission member 24, that is, along the Z direction and is exhausted from a plurality of through holes 25AB formed in the intermediate portion of the tubular member 25A in the Z direction. The cooling device 72 may be configured as an intake device, like the cooling device 71. In this case, the through holes 25AA are exhaust ports, and the through holes 25AB are intake ports. The cooling device 72 may be configured as a liquid cooling device.

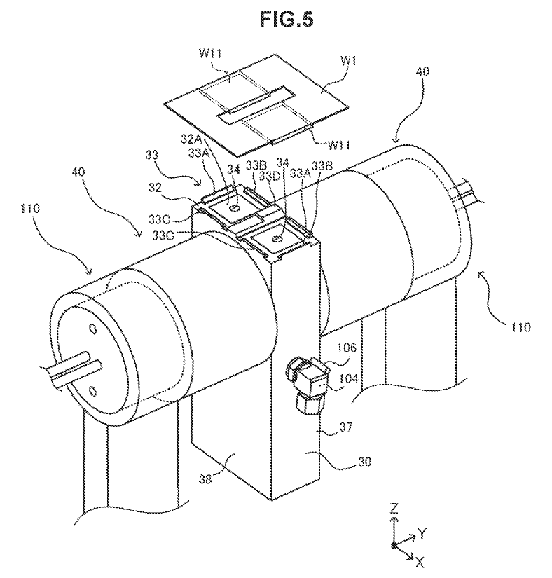

As shown in FIGS. 4 and 5, the stage 30 is formed into a rectangular parallelopiped having sides extending in the X direction, sides extending in the Y direction, and sides extending in the Z direction. The stage 30 is formed into a plate shape in which the sides in the Y direction are shorter than the sides in the X direction. The stage 30 supports the first member W1 of the workpiece W before joining. The stage 30 supports the workpiece W during and after joining of the first member W1 and the second members W2. The stage 30 ultrasonically vibrates during joining, thereby causing the workpiece W to ultrasonically vibrate. The ultrasonic vibration is applied from the side of the first member W1 to the workpiece W. By this application, the entire workpiece W may ultrasonically vibrate, or only the first member W1 in the workpiece W may ultrasonically vibrate. The joint strength is improved by the ultrasonic vibration.

The upper surface of the stage 30 is a support surface 32 that supports the first member W1 during joining. A convex portion 33 that positions the first member W1 by engaging with it is provided on the support surface 32. The convex portion 33 is formed into a shape conforming to the shape of the first member W1 of the workpiece W. Here, the convex portion 33 includes four types of convex portions 33A to 33D which, when the first member W1 is placed on the stage 30, surround two convex portions W11 of the first member W1 projecting downward from the side of the X direction and the Y direction and engage with the side surfaces of the convex portions W11.

Furthermore, two intake ports 34 that attract the first member W1 (more specifically, the convex portions W11) to the support surface 32 open in the support surface 32 of the stage 30. As shown in FIG. 4, the two intake ports 34 respectively connect to two intake paths 35 each having an L shape and passing in the stage 30. An end portion 35A of each intake path 35 on the side opposite to the intake port 34 opens in a side surface 37 of the stage 30. The side surface 37 connects to the support surface 32 and extends in a direction different from the support surface 32. Here, the side surface 37 is perpendicular to the support surface 32. As shown in FIGS. 4 and 5, a joint 104 is connected to each end portion 35A. The joint 104 is fitted in or threadably engages with the end portion 35A and is thus connected to the end portion 35A. The joints 104 are connected to the intake device 73 (FIGS. 1 an FIG. 2) via tubes (not shown). By air intake of the intake device 73, air around the intake ports 34 is drawn into the intake device 73 via the intake ports 34, the intake paths 35, the joints 104, and the tubes (not shown). Thus, the first member W1 is attracted to the support surface 32 by the intake ports 34. The intake ports 34 are formed in the bottom surfaces of concave portions 32A of the support surface 32 of the stage 30. Thus, the attraction area (the area to receive the force of air intake) of the first member W1 can be a surface corresponding to the entire concave portion 32A. The joint 104 is arranged at the position of a nodal point when the stage 30 ultrasonically vibrates.

A temperature sensor (for example, a thermocouple) 106 that detects the temperature of the stage 30 is mounted to the nodal point of the side surface 37 of the stage 30. The temperature detected by the temperature sensor 106 is supplied to the controller 60.

The two preheating devices 40 heat the stage 30 in noncontact before the first member W1 and the second members W2 of the workpiece W are joined. By this heating, the workpiece W supported by the stage 30 is preheated. The preheating is performed for the purpose of heating the workpiece W in advance such that the temperature of the workpiece W quickly reaches the joining temperature in joining. As shown in FIG. 5, the two preheating devices 40 may be supported by two support members 110, respectively. As the preheating device 40, for example, a halogen heater that heats the stage 30 by high-output light is employed.

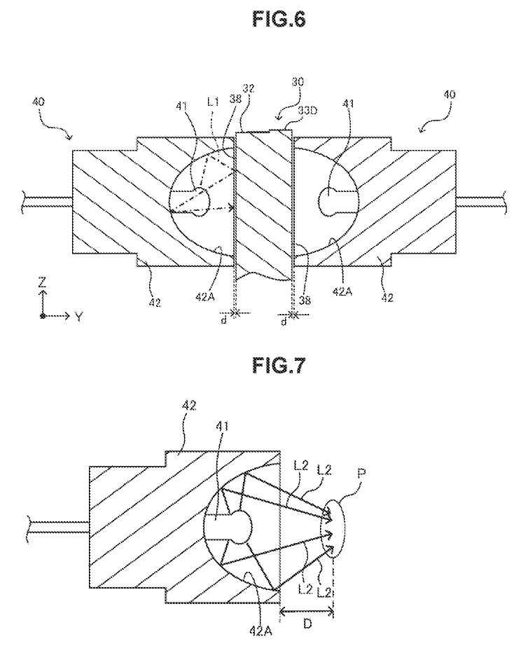

As shown in FIG. 6, the preheating device 40 includes a light source 41 and a reflecting member 42. Note that in FIG. 6, the internal structure of the preheating device 40 is simply illustrated. In actuality, a wiring, a circuit, and the like configured to supply a current to the light source 41 are implemented in the preheating device 40.

The light source 41 faces a side surface 38 of the stage 30 and emits heating light for heating the stage 30. The side surface 38 connects to the support surface 32 and extends in a direction different from the support surface 32. Here, the side surface 38 is perpendicular to the support surface 32. The side surface 38 also connects to the side surface 37 and extends in a direction different from the side surface 37. Here, the side surface 38 is perpendicular to the side surface 37. Since the stage 30 has a rectangular parallelopiped shape, the side surfaces 37 and 38 are formed as flat surfaces.

The housing of the preheating device 40 includes the reflecting member 42. The reflecting member 42 includes a reflecting surface 42A having a hood shape, which covers the light source 41 from the side opposite to the side surface 38 of the stage 30. An end portion of the reflecting surface 42A on the side of the side surface 38 (that is, an opening portion with the hood shape) is located closer to the side surface 38 than the light source 41. The whole region of the end portion of the reflecting surface 42A on the side of the side surface 38 (that is, the opening portion with the hood shape) is located in the side surface 38 when viewed from the Y direction. The reflecting surface 42A reflects, toward the side surface 38, reflected light that has been emitted from the light source 41A and reflected by the side surface 38 (for example, see the light indicated by an arrow L1) The reflecting surface 42A can function in this way because of not only the shape of the reflecting surface 42A but also the support position of the preheating device 40 by the support member 110. Note that the reflected light may include, in addition to light that is once reflected by the reflecting surface 42A after being emitted from the light source 41 and then is reflected by the side surface 38 as shown by the arrow L1, light that is directly emitted from the light source 41 to the side surface 38 and reflected thereby. Furthermore, the reflected light may include light that has been reflected a plurality of times by the reflecting surface 42A and/or the side surface 38. The heating light from the light source 41 that reaches the side surface 38 includes light that is absorbed by the side surface 38 and contributes to heating of the stage 30, and light that is reflected by the side surface 38 (that is, the reflected light). The heating light reflected by the side surface 38 can be reflected by the reflecting surface 42A and reach the side surface 38. The heating light reflected by the side surface 38 again can be reflected by the reflecting surface 42A again and reach the side surface 38 again. Thus, by providing the reflecting surface 42A, the opportunities for the heating light emitted from the light source 41A to reach the side surface 38 is increased, thereby improving heating efficiency of the heating light.

The reflecting surface 42A may be made of a material having a high reflectance such that the absorbance of heating light decreases. For example, the reflecting surface 42A is formed by gold plating or made of a gold thin film. On the other hand, the stage 30 may be made of a material having a high absorbance of heating light. As for the material, hardness and heat conductivity are also taken into consideration. To ensure a wear resistance to wear by ultrasonic vibration, the hardness of the stage 30 may be high. In addition, the heat conductivity of the stage 30 may be low such that heat is difficult to transmit to the side of the vibrator 21 when the stage 30 is heated. As a material of the stage 30, titanium oxide is available. The absorbance of heating light is 0.05 in gold and 0.8 in titanium oxide. By the relationship given by absorbance of reflecting surface 42A < absorbance on side surface 38, absorption of heating light by the reflecting surface 42A is suppressed, and the amount of absorption of heating light on the side surface 38 of the stage 30 increases. Thus, a high efficiency can be obtained as the heating efficiency of the stage 30 by heating light. Note that the larger the difference between the absorbance of the reflecting surface 42A and the absorbance on the side surface 38 is, the higher the obtained heating efficiency is. The difference can be made large by gold and titanium oxide. Note that titanium oxide may be employed as the material of the vibration transmission member 24 and the horn 22.

Note that to prevent leakage of heating light from the gap between the reflecting surface 42A and the preheating device 40, the preheating device 40 (particularly, the end portion of the reflecting surface 42A located on the side of the side surface 38 with respect to the light source 41) and the side surface 38 may be located close. For example, a distance d between these is d = 0.5 mm. Note that d may be a distance within the range of, for example, 0.01 mm to 10 mm. Also, d may be a distance within one of the ranges of, for example, 0.1 mm to 10 mm, 0.01 mm to 1 mm, and 0.1 mm to 1 mm.

In each preheating device 40, the reflecting surface 42A may be formed into such a shape that focuses heating light directly reaching from the light source 41 to the reflecting surface 42A as a spot to a predetermined focus P, like a plurality of light beams L2 shown in FIG. 7. The preheating device 40 is a spot heater. To implement the spot heater, the light source 41 may be configured not to directly emit heating light to the side surface 38 but to directly emit substantially all of heating light to the reflecting surface 42A. Also, to implement the spot heater, the light source 41 may be configured so that the emission angle of the heating light directed toward the side surface 38 is reduced. By the spot heater, the amount of heating light directed to a gap between the reflecting surface 42A and the preheating device 40 decreases, and light leakage can be prevented more. Note that the distance between the preheating device 40 (particularly, the end portion of the reflecting surface 42A located on the side of the side surface 38 with respect to the light source 41) and the focus P is also called a focal length D. The distance d may be shorter than the focal length D. Thus, the distance d between the reflecting surface 42A and the preheating device 40 becomes short, and leakage of heating light is effectively prevented. In addition, the heating light is irradiated onto a region in the side surface 38 wider than the focus P, and the side surface 38 is heated in a wide region.

The heater tool 50 shown in FIGS. 1 and 2 is moved up and down in the Z direction by the driving device 80. Note that the driving device 80 need only move the heater tool 50 and the stage 30 relatively in the Z direction, and may move the stage 30 and the vibration output device 20 up and down in addition to or instead of the heater tool 50. The heater tool 50 heats the workpiece W from the side of the second members W2 by, for example, pulse heat while pressing the second members W2 against the first member W1 during joining. Joining is performed by the heating. Before joining, the second members W2 may be placed on the first member W1 or may be held by the heater tool 50 by attraction. Also, if joining between the first member W1 and the second members W2 is soldering, solder is arranged between these. In the case that the second members W2 is held by the heater tool 50, holding of the second members W2 may be canceled during or after joining. A known configuration can be employed for the heater tool 50, and a detailed description thereof will be omitted.

The controller 60 shown in FIGS. 1 and 2 is configured to control the operation of the joining apparatus 10. The controller 60 is at least one of not less than one computer, not less than one FPGA (Field-Programmable Gate Array), and not less than one ASIC (Application Specific Integrated Circuit), or a combination thereof.

When joining the first member W1 and the second members W2 of the workpiece W, the controller 60 performs the following joining processing. Note that at the start of joining processing, the first member W1 is arranged on the support surface 32 of the stage 30. The first member W1 is positioned by the convex portion 33 formed on the support surface 32. The second members W2 are held by the heater tool 50. The heater tool 50 exists at an initial position apart from the stage 30.

After the start of joining processing, the controller 60 operates the intake device 73 and causes it to start air intake. Thus, air intake by the intake port 34 is started, and the first member W1 is attracted to the support surface 32.

After that, the controller 60 controls the power supply circuit 92 connected to the preheating devices 40 via wirings (not shown) to start power supply from the power supply circuit 92 to the preheating devices 40. The light sources 41 of the preheating devices 40 thus emit heating light, and the stage 30 is heated. The heating temperature at this time is a temperature (for example, 200°C) lower than the joining temperature of the first member W1 and the second members W2. Using the temperature of the stage 30 detected by the temperature sensor 106 as a feedback value, the controller 60 may feedback-controls the power supply circuit 92 (in other words, heating of the stage 30 by the preheating devices 40) such that the stage 30 is heated to a desired temperature. By the heating of the stage 30, the first member W1 is preheated. Note that the heating of the stage 30 may be started after the heater tool 50 starts pressing the second members W2 against the first member W1, as will be described later. In this case, the whole workpiece W is heated from the side of the first member W1. The heating of the stage 30 is maintained until heating by the heater tool 50 to be described later.

At the start of preheating, the controller 60 starts operating the cooling device 72. Thus, cooling of the vibration transmission member 24 by the cooling mechanism 25 is started, and transmission of heat of the stage 30 to the vibrator 21 is suppressed.

The controller 60 controls the driving device 80 to move the heater tool 50 down, thereby starting to press the second members W2 against the first member W1 by the heater tool 50. After that, the controller 60 controls the power supply circuit 91 and causes the vibrator 21 to ultrasonically vibrate. The ultrasonic vibration is output to the stage 30 via the horn 22 and the vibration transmission member 24. The ultrasonic vibration is amplified by the horn 22. The stage 30 ultrasonically vibrates upon input of the ultrasonic vibration. By the ultrasonic vibration of the stage 30, the ultrasonic vibration is applied to the workpiece W, from the side of the first member W1. By this application, the whole workpiece W may ultrasonically vibrate, or only the first member W1 of the workpiece W may ultrasonically vibrate. The latter phenomenon can occur particularly in a case where the second members W2 are firmly held by the heater tool 50. Note that if solder is interposed between the first member W1 and the second members W2, the solder may ultrasonically vibrate. Holding of the second members W2 by the heater tool 50 may be canceled before generation of the ultrasonic vibration or may be continued to time immediately before joining or after joining to be described later.

When starting causing the vibrator 21 to ultrasonically vibrate, the controller 60 starts operating the cooling device 71 to start cooling the vibrator 21.

The controller 60 controls the power supply circuit 93 connected to the heater tool 50 via a wiring (not shown) to start power supply from the power supply circuit 93 to the heater tool 50. The heater tool 50 thus generates heat, thereby starting to heat the workpiece W from the side of the second member W2, and realizing joining of the first member W1 and the second members W2. The controller 60 may detect the temperature of the heater tool 50 by a temperature sensor or the like and control the power supply circuit 93 (more specifically, electric energy to the heater tool 50) based on the detected temperature such that the temperature of the heater tool 50 becomes a desired temperature. The control of the power to the heater tool 50 via the power supply circuit 93 is performed by any suitable method (for example, power control for implementing pulse heat). The power supplied to the heater tool 50 via the power supply circuit 93 may be controlled by any other suitable method (for example, power control for implementing pulse heat).

After the end of power supply to the heater tool 50, that is, after completion of joining, the controller 60 controls the power supply circuits 91 and 92, thereby ending ultrasonic vibration generation and preheating. Note that these may be ended at any suitable timing. Furthermore, the controller 60 ends attraction of the first member W1 and each cooling operation at any suitable timing. To enable extraction of the workpiece W after joining, the controller 60 controls the driving device 80 to raise the heater tool 50 to the initial position.

As described above, the stage 30 of the joining apparatus 10 according to this embodiment includes the support surface 32 that supports at least the first member W1 among the first member W1 and the second members W2 included in the workpiece W, and the side surface 38 that connects to the support surface 32 and extends in a direction different from the support surface 32. Furthermore, the heater tool 50 heats the workpiece W from the side of the second members W2 in a state in which the second members W2 are arranged on the first member W1 supported by the support surface 32, thereby joining the first member W1 and the second members W2. Furthermore, the vibration output device 20 includes the vibrator 21 configured to ultrasonically vibrate, and causes the stage 30 to ultrasonically vibrate during the joining. The preheating device 40 heats the stage 30 in noncontact before the joining, thereby preheating at least the first member W1 of the workpiece W. The preheating device 40 includes the light source 41 that faces the side surface 38 of the stage 30 and emits heating light for heating the stage 30, and the reflecting surface 42A that has a hood shape and covers the light source 41 from the side opposite to the side surface 38. The reflecting surface 42A is configured to reflect, toward the side surface 38, light reflected by the side surface 38 among the heating light emitted by the light source 41. With this configuration, the stage 30 can apply the ultrasonic vibration to the workpiece W by ultrasonically vibrating and cause the workpiece W to ultrasonically vibrate. Also, since the preheating device 40 that heats the stage 30 in noncontact includes the reflecting surface 42A, heating light that has been reflected by the side surface 38 can be reflected by the reflecting surface 42A and reach the side surface 38 again. Hence, the opportunities of the heating light reaching the side surface 38 increase, the amount of absorption of heating light by the side surface 38 increases accordingly, and heating efficiency by heating light is improved. As described above, according to this embodiment, it is possible to heat the stage 30 at a high heating efficiency even by heating in noncontact.

In addition, the preheating device 40 is configured as a spot heater in which the reflecting surface 42A is formed into such a shape that focuses, of the heating light, light directly reaching from the light source 41 to the reflecting surface 42A. This decreases the amount of heating light directed to a gap between the preheating device 40 and the reflecting surface 42A and, as a result, the amount of heating light leaked from the gap between the preheating device 40 and the reflecting surface 42A is decreased, thus the stage 30 is heated at a high heating efficiency.

The distance d between the preheating device 40 and the side surface 38 may be shorter than the focal length D of heating light focused by the preheating device 40 serving as a spot heater. This can reduce the distance between the preheating device 40 and the reflecting surface 42A and the amount of heating light leaked from the gap therebetween, thereby obtaining high heating efficiency. In addition, the heating light irradiation region of the side surface 38 is wider than the focus P of heating light, and the side surface 38 is heated in a wide range. Furthermore, since the reflecting surface 42A reflects heating light that has been reflected by the side surface 38 as well, the stage 30 is heated at a high heating efficiency.

Also, when the preheating device 40 is arranged close to the side surface 38, the distance between the preheating device 40 and the reflecting surface 42A can be made narrow, thus the amount of heating light leaked from the gap between these is reduced, and the stage 30 is heated at a high heating efficiency. As described above, the close distance between these may be a distance within the range of 0.01 mm to 1.0 cm. Also, the close distance may be a distance within one of the ranges of, for example, 0.1 mm to 10 mm, 0.01 mm to 1 mm, and 0.1 mm to 1 mm. The close distance is such a distance that prevents the preheating device 40 from contacting the ultrasonically vibrating stage 30.

In addition, the absorbance of heating light on the reflecting surface 42A is lower than the absorbance of heating light on the side surface 38. Hence, the heating light reflected by the reflecting surface 42A and the side surface 38 is finally absorbed by the side surface 38 at higher probability than the reflecting surface 42A, and the stage 30 is thus heated at a high heating efficiency.

Note that as is apparent from FIG. 5, the support surface 32 is formed into a rectangle having a first side extending in the X direction and a second side extending in the Y direction, and the stage 30 is formed into a rectangular parallelopiped shape. The first side is longer than the second side. Furthermore, the side surface 38 is a surface having the first side as one side. Note that the side surface 37 is a surface having the second side as one side. With the above-described configuration, the thickness (the length in the Y direction) of the stage 30 in the heating light irradiation direction (Y direction) can be made small. Thus, the temperature of the stage 30 can quickly be raised to a desired temperature, and heating unevenness in the thickness direction of the stage 30 is reduced. Note that since the side surface 38 is a flat surface, heating light is efficiently absorbed by the side surface 38. The side surface 38 may be formed into a shape such that at least a portion thereof to be irradiated with heating light is flat. The shapes of other portions of the stage 30 are no limited.

Furthermore, in this embodiment, the two preheating devices 40 heat the two side surfaces 38 of the stage 30, which are opposite sides parallel to each other, respectively. This makes it possible to heat the stage 30 from two directions, quickly raise the temperature of the stage 30 to a desired temperature, and reduce heating unevenness in the direction from one side surface 38 to the other side surface 38. Also, as described above, the support surface 32 is formed into a rectangle having two first sides extending in the X direction and two second sides extending in the Y direction. The first side is longer than the second side. Furthermore, The two side surfaces 38 are surfaces, each having a respective one of the two first sides as one side. With the above-described configuration, the thickness (the length in the Y direction) of the stage 30 in the heating light irradiation direction (Y direction) can be made small, and heating unevenness in the thickness direction of the stage 30 is reduced.

Also, in this embodiment, the stage 30 includes the convex portion 33 that positions the first member W1 by engaging with the first member W1. The convex portion 33 is formed on the support surface. The convex portion 33 suppresses a position deviation of the first member W1 during ultrasonic vibration of the stage 30.

Furthermore, the intake ports 34 that take in air open in the support surface 32, and the support surface 32 is configured to attract the first member W1 by air taken in through the intake ports 34. With the attraction, a position deviation of the first member W1 at the time of ultrasonic vibration of the stage 30 is suppressed.

Additionally, the intake paths 35 which connect to the intake ports 34 and through which the air taken in by the intake ports 34 passes are formed inside the stage 30. The opening position, on the stage 30, of the end portion 35A of each intake path 35 apart from the intake port 34 is the position of the nodal point when the stage 30 ultrasonically vibrates. This reduces ultrasonic vibration of a member for intake connected to the opening position, thereby reducing degradation of the member caused by the ultrasonic vibration. In particular, the joints 104 is connected to end portions 35A, and the intake devices 73 take in air around the intake ports 34 via the joints 104, the intake paths 35, and the intake ports 34. In this case, the ultrasonic vibration of the joints 104 and tubes (not shown) connected to the joints 104 is reduced, and degradation of these caused by the ultrasonic vibration is reduced.

The vibration output device 20 includes the horn 22 that amplifies the ultrasonic vibration output from the vibrator 21, the vibration transmission member 24 that transmits the ultrasonic vibration amplified by the horn 22 to the stage 30, and the cooling mechanism 25 that cools the vibration transmission member 24. With this configuration, even if heat from the stage 30 is transmitted to the vibration transmission member 24, the vibration transmission member 24 is cooled by the cooling mechanism 25 and, therefore, the heat of the stage 30 is difficult to transmit to the horn 22 and the vibrator 21. Furthermore, since the vibration transmission member 24 is provided, the distances from the horn 22 and the vibrator 21 to the stage 30 can be made long, and the heat of the stage 30 is more difficult to transmit to the horn 22 and the vibrator 21.

Note that as is apparent from FIGS. 1 and 2, the preheating device 40 may be configured to irradiate heating light to an upper end portion of the stage 30 (an end portion on the side of the support surface 32), and not to irradiate a lower end portion opposite to the upper end portion. Since a temperature gradient can thus be provided between the lower end portion of the stage 30, which is the end portion on the side of the vibration output device 20, and the upper end portion that is the heating light irradiation position, the rise of the temperature of the lower end portion is suppressed, and the influence of heat on the vibrator 21 and the like can be reduced.

The cooling mechanism 25 includes the tubular member 25A that covers the vibration transmission member 24, and is configured to supply a refrigerant between the vibration transmission member 24 and the tubular member 25A. The refrigerant is air from the cooling device 72, or the like. With this configuration, cooling of the vibration transmission member 24 is implemented by a simple configuration. Note that the seal members 25B that are interposed between the vibration transmission member 24 and the tubular member 25A and thus support the tubular member 25A may be arranged at the positions of nodal points when the vibration transmission member 24 ultrasonically vibrates. This reduces vibration transmission to the tubular member 25A.

The vibration output device 20 further includes the support member 23 serving as the cooling mechanism that cools the vibrator 21. This suppresses the rise of the temperature of the vibrator 21.

Also, the joining apparatus 10 further includes the temperature sensor 106 that detects the temperature of the stage 30, and the controller 60 that controls heating of the stage 30 by the preheating devices 40 based on the temperature detected by the temperature sensor 106. The temperature sensor 106 is fixed to the stage 30 at the nodal point when the stage 30 ultrasonically vibrates. This reduces the adverse effect of the ultrasonic vibration of the stage 30 to the temperature sensor 106.

Note that according to this embodiment, configuration A described below is obtained as a configuration for achieving the object of making it difficult for heat of the stage 30 to be transmitted to the vibrator 21. According to configuration A, it is possible to make it difficult for the heat of the stage 30 to be transmitted to the vibrator 21 (including not transmitted). In this case of configuration A, the preheating device 40 may contact the stage 30 to heat it. The specific configuration for implementing configuration A is not limited to the configuration of the above embodiment, and any configuration of the above embodiment may be applied to configuration A.

### Configuration A

There is provided a joining apparatus comprising:

a stage including a support surface that is configured to support at least a first member among the first member and a second member included in a workpiece, and a first side surface that connects to the support surface and extends in a direction different from the support surface;

a heater tool configured to heat the workpiece from a side of the second member in a state in which the second member is arranged on the first member supported by the support surface, thereby joining the first member and the second member;

a vibration output device including a vibrator that is configured to ultrasonically vibrate and configured to cause the stage to ultrasonically vibrate during the joining; and

a preheating device configured to heat the stage before the joining, thereby preheating at least the first member of the workpiece,

wherein the vibration output device further includes:

a horn configured to amplify the ultrasonic vibration from the vibrator;

a vibration transmission member configured to transmit the amplified ultrasonic vibration to the stage; and

a cooling mechanism configured to cool the vibration transmission member.

The present disclosure can generally be applied not only to a joining apparatus but also a heating system that heats a heating target in noncontact, in addition to a joining apparatus. The heating system may have the following configuration B. An example of the heating target is a member that is difficult to heat in contact because of vibration. Any part of the configuration according to the embodiment may be applied to the following heating system. For example, any part of the configuration of the stage 30 may be applied as the shape of the heating target. In addition, any part of the configuration of the preheating device 40 can be applied as the configuration of a heating device.

### Configuration B

There is provided a heating system comprising:

a heating device configured to heat the heating target in noncontact, including

a light source configured to face a heating target and emit heating light for heating the heating target and

a reflecting surface that has a hood shape and covers the light source from a side opposite to the heating target; and

a support member configured to support the heating device at a position at which the reflecting surface is able to reflect, toward the heating target, light that has been reflected by the heating target among the heating light.

### Scope of Present Disclosure

The present disclosure is not limited to the above embodiment. For example, the present disclosure includes various changes for the embodiments and the modifications, which can be understood by those skilled in the art within the technical scope of the present disclosure. The configurations explained in the embodiments and the modifications can appropriately be combined withing a consistent range. Also, any configuration in the above-described configurations can be deleted.

This application claims the benefit of Japanese Patent Application No. 2024-170497, filed on September. 30, 2024, the entire disclosure of which is incorporated by reference herein.

### Appendices

Configurations including at least part of the embodiments and the modifications as examples will be exemplified below. Only any partial configuration of the embodiments and the modifications can be applied to each Appendix. Also, parts of the Appendices may be combined.

### Appendix 1

A joining apparatus comprising: a stage including a support surface that is configured to support at least a first member among the first member and a second member included in a workpiece, and a first side surface that connects to the support surface and extends in a direction different from the support surface; a heater tool configured to heat the workpiece from a side of the second member in a state in which the second member is arranged on the first member supported by the support surface, thereby joining the first member and the second member; a vibration output device including a vibrator that is configured to ultrasonically vibrate and configured to cause the stage to ultrasonically vibrate during the joining; and a first preheating device configured to heat the stage in noncontact before the joining, thereby preheating at least the first member of the workpiece, wherein the first preheating device includes: a light source that faces the first side surface of the stage and is configured to emit heating light for heating the stage; and a reflecting surface that has a hood shape and covers the light source from a side opposite to the first side surface, the reflecting surface being configured to reflect, toward the first side surface, light that has been reflected by the first side surface among the heating light.

### Appendix 2

The joining apparatus according to Appendix 1, wherein the first preheating device is a spot heater in which the reflecting surface has a shape configured to focus, among the heating light, light directly reaching the reflecting surface from the light source.

### Appendix 3

The joining apparatus according to Appendix 2, wherein a distance between the first preheating device and the first side surface is shorter than a focal length of the heating light focused by the preheating device that is the spot heater.

### Appendix 4

The joining apparatus according to any one of Appendix 1 to 3, wherein the first preheating device is close to the first side surface.

### Appendix 5

The joining apparatus according to Appendix 4, wherein the distance between the first preheating device and the first side surface is a distance within a range of 0.01 mm to 1.0 cm.

### Appendix 6

The joining apparatus according to any one of Appendix 1 to 5, wherein an absorbance of the heating light on the reflecting surface is lower than an absorbance of the heating light on the first side surface.

### Appendix 7

The joining apparatus according to any one of Appendix 1 to 6, wherein the support surface is a rectangle having a first side extending in an X direction and a second side extending in a Y direction orthogonal to the X direction, the first side is longer than the second side, and the first side surface has the first side as one side of the first side surface.

### Appendix 8

The joining apparatus according to any one of Appendix 1 to 7, Wherein the stage further includes a second side surface that connects to the support surface and is parallel to and opposite to the first side surface, the joining apparatus further comprises a second preheating device configured to heat the stage in noncontact before the joining, thereby preheating at least the first member of the workpiece, and the second preheating device includes: a light source that faces the second side surface of the stage and is configured to emit heating light for heating the stage; and a reflecting surface that has a hood shape and covers the light source from a side opposite to the second side surface, the reflecting surface being configured to reflect, toward the second side surface, light that has been reflected by the second side surface among the heating light.

### Appendix 9

The joining apparatus according to Appendix 8, wherein the support surface is a rectangle having two first sides extending in the X direction and two second sides extending in the Y direction orthogonal to the X direction, the two first sides are longer than the two second sides, and the first side surface has one of the two first sides as one side of the first side surface, and the second side surface has the other of the two first sides as one side of the second side surface.

### Appendix 10

The joining apparatus according to any one of Appendix 1 to 9, wherein the stage further includes a convex portion located on the support surface and configured to position the first member by engaging with the first member.

### Appendix 11

The joining apparatus according to any one of Appendix 1 to 10, wherein an intake port configured to take in air is open in the support surface, and the support surface is configured to attract the first member by taking in air via the intake port.

### Appendix 12

The joining apparatus according to any one of Appendix 1 to 11, wherein

the stage further includes an intake path which connects to the intake port and through which the air taken in by the intake port passes, and

an opening position, on the stage, of an end portion of the intake path is at a nodal point when the stage ultrasonically vibrates, the end portion being located on a side opposite to the intake port.

### Appendix 13

The joining apparatus according to Appendix 12, further comprising: a joint connected to the end portion; and an intake device configured to take in air around the intake port via the joint, the intake path, and the intake port.

### Appendix 14

The joining apparatus according to any one of Appendix 1 to 13, wherein the vibration output device further includes: a horn configured to amplify the ultrasonic vibration from the vibrator; a vibration transmission member configured to transmit the amplified ultrasonic vibration to the stage; and a first cooling mechanism configured to cool the vibration transmission member.

### Appendix 15

The joining apparatus according to Appendix 14, wherein the first cooling mechanism includes a tubular member that covers the vibration transmission member, and the first cooling mechanism is configured to supply a refrigerant between the vibration transmission member and the tubular member.

### Appendix 16

The joining apparatus according to Appendix 14, wherein the vibration output device further includes a second cooling mechanism configured to cool the vibrator.

### Appendix 17

The joining apparatus according to any one of Appendix 1 to 16, further comprising: a temperature sensor configured to detect a temperature of the stage; and a controller configured to control heating of the stage by the first preheating device based on the temperature detected by the temperature sensor, wherein the temperature sensor is located on a nodal point of the stage when the stage ultrasonically vibrates.

### Appendix 18

A joining apparatus comprising: a stage including a support surface that is configured to support at least a first member among the first member and a second member included in a workpiece, and a first side surface that connects to the support surface and extends in a direction different from the support surface; a heater tool configured to heat the workpiece from a side of the second member in a state in which the second member is arranged on the first member supported by the support surface, thereby joining the first member and the second member; a vibration output device including a vibrator that is configured to ultrasonically vibrate and configured to cause the stage to ultrasonically vibrate during the joining; and a preheating device configured to heat the stage before the joining, thereby preheating at least the first member of the workpiece, wherein the vibration output device further includes: a horn configured to amplify the ultrasonic vibration from the vibrator; a vibration transmission member configured to transmit the amplified ultrasonic vibration to the stage; and a cooling mechanism configured to cool the vibration transmission member. As for the configuration, the configuration according to any one of Appendix 1 to 17 can be applied.

### Appendix 19

A heating system comprising: a heating device configured to heat the heating target in noncontact, including a light source configured to face a heating target and emit heating light for heating the heating target and a reflecting surface that has a hood shape and covers the light source from a side opposite to the heating target; and a support member configured to support the heating device at a position at which the reflecting surface is able to reflect, toward the heating target, light that has been reflected by the heating target among the heating light. As for the configuration, the configuration according to any one of Appendix 1 to 17 can be applied.

### EXPLANATION OF THE REFERENCE NUMERALS AND SIGNS

10...joining apparatus, 20...vibration output device, 21...vibrator, 21A - 21D...terminal, 22...horn, 22A...horn main body, 22B...flange, 23...support member, 23A...connecting member, 23AA - 23AB...elastic member, 23AC - 23AD...clamp member, 23B...tubular member, 23C...cover, 24...vibration transmission member, 25...cooling mechanism, 25A...tubular member, 25AA - 25AB...through hole, 25B...seal member, 30...stage, 31...threaded hole, 32...support surface 32, 32A...concave portion, 33, 33A - 33D...convex portion, 34...intake port, 35...intake path, 35A...end portion, 37, 38...side surface, 40...preheating device, 41...light source, 42...reflecting member, 42A...reflecting surface, 50...heater tool, 60...controller, 71, 72...cooling device, 73...intake device, 80...driving device, 91 - 93...power supply circuit, 101...connector, 102 - 104...joint, 106...temperature sensor, 110...support member, d...distance, D...focal length, L1...arrow, L2...light, N1...double end screw, P...focus, W...workpiece, W1...first member, W2...second member, W11...convex portion.

1. A joining apparatus comprising:
a stage including a support surface that is configured to support at least a first member among the first member and a second member included in a workpiece, and a first side surface that connects to the support surface and extends in a direction different from the support surface;
a heater tool configured to heat the workpiece from a side of the second member in a state in which the second member is arranged on the first member supported by the support surface, thereby joining the first member and the second member;
a vibration output device including a vibrator that is configured to ultrasonically vibrate and configured to cause the stage to ultrasonically vibrate during the joining; and
a first preheating device configured to heat the stage in noncontact before the joining, thereby preheating at least the first member of the workpiece,
wherein the first preheating device includes:
a light source that faces the first side surface of the stage and is configured to emit heating light for heating the stage; and
a reflecting surface that has a hood shape and covers the light source from a side opposite to the first side surface, the reflecting surface being configured to reflect, toward the first side surface, light that has been reflected by the first side surface among the heating light.

2. The joining apparatus according to claim 1, wherein
the first preheating device is a spot heater in which the reflecting surface has a shape configured to focus, among the heating light, light directly reaching the reflecting surface from the light source.

3. The joining apparatus according to claim 2, wherein
a distance between the first preheating device and the first side surface is shorter than a focal length of the heating light focused by the preheating device that is the spot heater.

4. The joining apparatus according to claim 1, wherein
the first preheating device is close to the first side surface.

5. The joining apparatus according to claim 4, wherein
the distance between the first preheating device and the first side surface is a distance within a range of 0.01 mm to 1.0 cm.

6. The joining apparatus according to claim 1, wherein
an absorbance of the heating light on the reflecting surface is lower than an absorbance of the heating light on the first side surface.

7. The joining apparatus according to claim 1, wherein
the support surface is a rectangle having a first side extending in an X direction and a second side extending in a Y direction orthogonal to the X direction,
the first side is longer than the second side, and
the first side surface has the first side as one side of the first side surface.

8. The joining apparatus according to claim 1, Wherein
the stage further includes a second side surface that connects to the support surface and is parallel to and opposite to the first side surface,
the joining apparatus further comprises a second preheating device configured to heat the stage in noncontact before the joining, thereby preheating at least the first member of the workpiece, and
the second preheating device includes:
a light source that faces the second side surface of the stage and is configured to emit heating light for heating the stage; and
a reflecting surface that has a hood shape and covers the light source from a side opposite to the second side surface, the reflecting surface being configured to reflect, toward the second side surface, light that has been reflected by the second side surface among the heating light.

9. The joining apparatus according to claim 8, wherein
the support surface is a rectangle having two first sides extending in the X direction and two second sides extending in the Y direction orthogonal to the X direction,
the two first sides are longer than the two second sides, and
the first side surface has one of the two first sides as one side of the first side surface, and the second side surface has the other of the two first sides as one side of the second side surface.

10. The joining apparatus according to claim 1, wherein
the stage further includes a convex portion located on the support surface and configured to position the first member by engaging with the first member.

11. The joining apparatus according to claim 1, wherein
an intake port configured to take in air is open in the support surface, and
the support surface is configured to attract the first member by taking in air via the intake port.

12. The joining apparatus according to claim 1, wherein
the stage further includes an intake path which connects to the intake port and through which the air taken in by the intake port passes, and
an opening position, on the stage, of an end portion of the intake path is at a nodal point when the stage ultrasonically vibrates, the end portion being located on a side opposite to the intake port.

13. The joining apparatus according to claim 12, further comprising:
a joint connected to the end portion; and
an intake device configured to take in air around the intake port via the joint, the intake path, and the intake port.

14. The joining apparatus according to claim 1, wherein
the vibration output device further includes:
a horn configured to amplify the ultrasonic vibration from the vibrator;
a vibration transmission member configured to transmit the amplified ultrasonic vibration to the stage; and
a first cooling mechanism configured to cool the vibration transmission member.

15. The joining apparatus according to claim 14, wherein
the first cooling mechanism includes a tubular member that covers the vibration transmission member, and
the first cooling mechanism is configured to supply a refrigerant between the vibration transmission member and the tubular member.

16. The joining apparatus according to claim 14, wherein
the vibration output device further includes a second cooling mechanism configured to cool the vibrator.

17. The joining apparatus according to claim 1, further comprising:
a temperature sensor configured to detect a temperature of the stage; and
a controller configured to control heating of the stage by the first preheating device based on the temperature detected by the temperature sensor,
wherein the temperature sensor is located on a nodal point of the stage when the stage ultrasonically vibrates.

18. A heating system comprising:
a heating device configured to heat the heating target in noncontact, including
a light source configured to face a heating target and emit heating light for heating the heating target and
a reflecting surface that has a hood shape and covers the light source from a side opposite to the heating target; and
a support member configured to support the heating device at a position at which the reflecting surface is able to reflect, toward the heating target, light that has been reflected by the heating target among the heating light.
